(19) United States
(12) Patent Application Publication
(10) Pub. No.: US 2026/0318215 A1
(43) Pub. Date: Oct. 15, 2026

(54) SEAL CARRIER ARRANGEMENT FOR A TURBOMACHINE

(71) Applicant: MTU Aero Engines AG, Munich (DE)

(72) Inventors: Antonios DAILIANIS, Munich (DE); Manfred FELDMANN, Munich (DE); Amelia SAK, Jasionka (PL); Laura DONIGA-CRIVAT, Munich (DE)

(21) Appl. No.: 19/541,424

(22) Filed: Feb. 17, 2026

(30) Foreign Application Priority Data
Feb. 19, 2025 (DE) 102025106233.1

(51) Int. Cl. F01D 11/00

(52) U.S. Cl. CPC F01D 11/005; F05D 2240/55

(57) ABSTRACT

A sealing carrier arrangement for a turbomachine, including a housing part, a seal carrier, and a clamp, with which the seal carrier is connected radially inward to the housing part. The clamp has a radially extending connecting web. A retaining element is provided radially on an inside of the connecting web and supports the seal carrier radially on an inside. The clamp includes retaining arms provided radially on an outside of the connecting web. The retaining arms extend in a T-shaped manner away from the connecting web, as seen in an axial direction, and are seated on the housing part in a radially inward-supported manner.

### CROSS REFERENCE TO RELATED APPLICATIONS

This application claims benefit to German Patent Application No. DE 10 2025 106 233.1, filed on Feb. 19, 2025, which is hereby incorporated by reference herein.

### FIELD

The present invention relates to a seal carrier arrangement for a turbomachine.

### BACKGROUND

As explained in detail below, the turbomachine may be, in particular, an aircraft engine, for example a turbofan engine. One component of the turbomachine is a so-called seal carrier, which encloses the gas channel radially outward in the area of a rotor blade ring. A sealing structure, e.g. an abradable coating, can be provided radially on the inside of the seal carrier. During operation, the moving blades, which rotate in the circumferential direction, can, for example, sweep along the sealing structure or the abradable coating with their blade tips.

### SUMMARY

In an embodiment, the present disclosure provides a sealing carrier arrangement for a turbomachine, comprising a housing part, a seal carrier, and a clamp, with which the seal carrier is connected radially inward to the housing part. The clamp has a radially extending connecting web. A retaining element is provided radially on an inside of the connecting web and supports the seal carrier radially on an inside. The clamp includes retaining arms provided radially on an outside of the connecting web. The retaining arms extend in a T-shaped manner away from the connecting web, as seen in an axial direction, and are seated on the housing part in a radially inward-supported manner.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a turbomachine, specifically a turbofan engine, in a schematic axial section;

FIG. 2a and FIG. 2b show a seal carrier arrangement with seal carrier and housing part in axial sections;

FIG. 3 shows a seal carrier arrangement with a clamp in an axial view; and

FIG. 4 shows the clamp according to FIG. 3 in a detailed representation.

### DETAILED DESCRIPTION

In an embodiment, the present disclosure relates to a seal carrier arrangement which, in addition to the seal carrier, has a housing part on which the seal carrier is mounted. In this case, the housing part is arranged radially outside the seal carrier; in other words, the seal carrier segment is suspended radially inside on the housing part.

The present disclosure provides an advantageous seal carrier arrangement for a turbomachine.

This is achieved according to an embodiment of the present disclosure with a seal carrier arrangement in which the seal carrier is fastened to the housing part by means of a clamp. The clamp has a radially extending connecting web on which a retaining element is provided radially on the inside and retaining arms are provided radially on the outside. The retaining element, which can be provided, for example, in the form of retaining webs (see in detail below), supports the seal carrier radially inward. The clamp rests, radially supported, on the housing part with the retaining arms, i.e. it is supported radially inward. In this case, the retaining arms extend away from the connecting web in a T-shaped manner, as seen in the axial direction. In other words, the retaining arms each extend away from the connecting web in the circumferential direction.

The clamp with the connecting web and the retaining arms, which extend in the circumferential direction opposite to one another away from the connecting web, can produce a robust and stable design, for example exhibiting an improved tolerance to oscillation. A cross-sectional area for the connecting web, can be selected, for example, so that the mechanical stresses remain below a critical level. In an alternative design, for example a clamp which is C-shaped in an axial section, on the other hand, higher bending stresses can occur and, if the dimensions are small, high stress levels can occur (which conversely can reduce tolerance to oscillation).

Preferred embodiments are found throughout the present disclosure, whereby the description of the features does not always differentiate in detail between apparatus and process or use aspects; in any case, the disclosure is implicit with regard to all of such categories.

The terms “axial,” “radial” and “circumferential,” as well as the associated directions (axial direction, radial directions and circumferential [rotation] direction), relate within the scope of this disclosure to the longitudinal axis of the turbomachine, which can coincide in particular with an axis of rotation of its rotors. In other words, the data relate to the axis of rotation of a rotor or rotor blade ring arranged radially inside the seal carrier. The T-shape of the retaining arms on the connecting web results when viewed in the axial direction, i.e. in relation to a viewing direction parallel to the axis.

The retaining arms are supported radially inward by the housing part; in detail, they can rest on the support surface of the housing part. This support surface can be formed, for example, by an axially protruding rib or projection (as its outer lateral surface). The seal carrier arrangement is preferably provided in the area of the turbine, wherein the axial rib of the housing part can protrude in the opposite direction to the flow direction of the gas channel.

According to an embodiment, a respective retaining arm of the clamp is seated with its free end in a radially prestressed manner on the support surface of the housing part. The free end of the respective retaining arm is deflected radially outward when mounted, and a restoring force therefore acts conversely radially inward. The respective retaining arm is suspended from the connecting block at its end opposite the free end, which is turned away from the connecting block in the direction of travel.

According to an embodiment, the connecting web has a mounting means, which is used to attach a mounting tool when the clamp is mounted. The mounting means can preferably be provided in the form of a recess, in particular a hole, in the connecting block. A spreading tool, for example, can be supported therein, with which the free ends of the retaining arms can be deflected when the clamp is inserted (in order to then place prestressed on the support surface of the housing part, see front).

In an embodiment, the retaining element formed radially on the inside of the connecting web has a first and a second retaining web. These extend in the circumferential direction opposite one another away from the connecting web (that is to say likewise T-shaped).

According to an embodiment, a respective retaining arm extends in the circumferential direction further away from the connecting web than the respective retaining web. Specifically, the first retaining web and a first retaining arm, which are arranged on the same circumferential side of the connecting web, can thus be compared; likewise, the second retaining rib and a second retaining arm, which are arranged on the opposite circumferential side of the connecting web, are compared with one another. An extension of the first retaining arm away from the connecting web in the circumferential direction can, for example, be at least 1.5, 2.5 or 3 times the extension of the first retaining web likewise away from the connecting web in the circumferential direction (with possible upper limits in the case of, for example, 30, 20 or 10 times). An extension of the second retaining arm away from the connecting web in the opposite direction can, for example, be at least 1.5, 2.5 or 3 times the extension of the second retaining web likewise away from the connecting web in the circumferential direction (with possible upper limits in the case of, for example, 30, 20 or 10 times).

Regardless of the values in detail, the shorter retaining webs can be stiffer, whereas the longer retaining arms can be more flexible. During operation, a radial temperature gradient can be established so that the seal carrier is hotter than the housing part. Accordingly, the hotter seal carrier is supported by the relatively shorter retaining webs and the relatively longer retaining arms are supported on the cooler housing part.

In an embodiment, the retaining arms, the connecting web and the retaining webs lie in a common plane. Thus, for example, a comparatively simple and stable construction can be achieved. The common plane can, for example, lie essentially perpendicular to the axial direction.

In an embodiment, each retaining web transitions into the connecting web with a rounded edge. With the rounding, notch stress can be optimized or reduced, for which purpose, for example, a plurality of (at least two) radii of curvature can also be combined or, in general, a variable radius of curvature can be set.

In an embodiment, each retaining arm transitions into the connecting web with a rounded edge. With the rounding notch stress can be optimized or reduced, for which purpose, for example, a plurality of (at least two) radii of curvature can also be combined or, in general, a variable radius of curvature can be set.

According to an embodiment, the support surface of the housing part on which the retaining arms lie is provided with an interruption. The connecting web is arranged in this interruption. Viewed in the axial direction, one retaining arm is arranged on the support surface area on one circumferential side and the other retaining arm is arranged on the support surface region on the opposite circumferential side. The interruption can be provided, for example, in an axially protruding rib of the housing part (see front).

The connecting web arranged in the interruption can, in addition to the radial suspension, also provide the circumferential fixation of housing part and seal carrier. For this purpose, the seal carrier preferably also has an axially protruding rib, which is arranged radially within the axial rib of the housing part. The axial rib of the seal carrier is then also preferably provided with an interruption, this being radially aligned with the interruption in the axial rib of the housing part.

In an embodiment, the seal carrier is segmented in the circumferential direction and the clamp is provided in the middle section of the seal carrier segment with respect to the circumferential direction. In other words, fastening takes place at a distance from the ends of the seal carrier segment on the circumferential side, i.e. they can move “freely” (for example in the case of a thermally induced deformation, as a rule a widening of the radius).

With reference to the circumferential extent of the seal carrier segment, which is 0% at one circumferential end and 100% at the opposite circumferential end, the middle section is preferably between 20% and 80%, more preferably between 30% and 70%. The clamp is arranged in the middle area, its position generally being determined by the position of the connecting web. In general, therefore, the retaining arms can extend farther outward, but it is particularly preferable for the entire clamp to be arranged in the middle area.

According to an embodiment, no clamp is arranged at each of the joints between two adjacent seal carrier segments, i.e. the joints are clamp-free. As mentioned above, it is thus made possible, for example, to reduce the mechanical stress arising in thermally induced deformations.

In an embodiment, exactly one clamp is provided for each seal carrier segment. In this case, the respective clamp can be provided in the middle section of each seal carrier segment, for example, see front.

The present disclosure further relates to a turbomachine having the seal carrier arrangement disclosed here. The turbomachine can be, in particular, an aircraft engine, for example a turbofan engine. The seal carrier arrangement can preferably be part of the turbine of the turbomachine, for example of the low-pressure turbine.

The present disclosure further relates to a method for producing the seal carrier arrangement disclosed in the present case, in particular a turbomachine having such a seal carrier arrangement. In this case, the seal carrier is placed on the housing part and fastened with the clamp, the free ends of the retaining arms of the clamp preferably being deflected radially outward in this case and the clamp then being inserted axially, after which the retaining arms rest in a prestressed manner on the support surface of the housing part.

Embodiments of the present disclosure will be explained in more detail below using exemplary embodiments, whereby the individual features within the scope of various embodiments can also be essential in other combinations, and no distinction will be made in detail between the different embodiment categories.

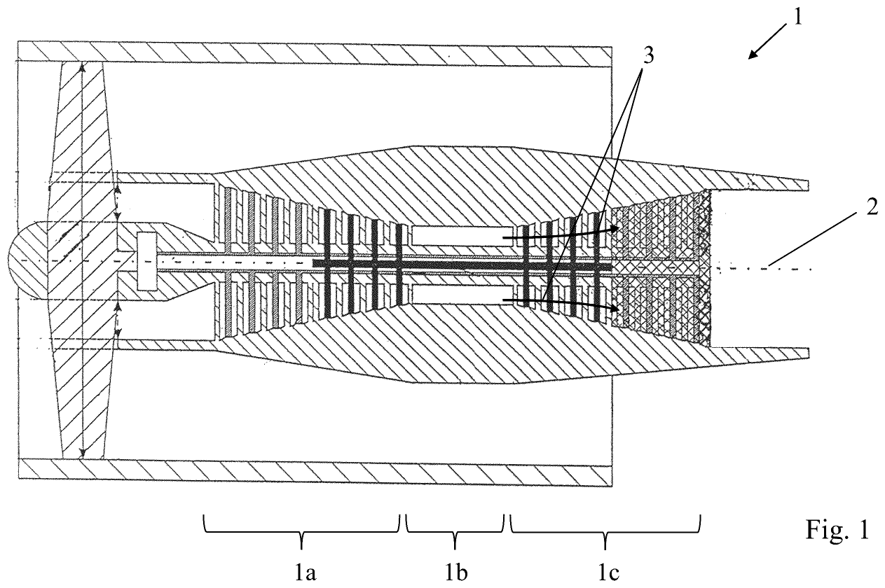

FIG. 1 shows an axial section of a turbomachine 1, specifically a turbofan engine. The turbomachine 1 is functionally divided into a compressor 1a, a combustion chamber 1b and a turbine 1c. Both the compressor la and the turbine 1c are constructed from a plurality of stages (each compressor stage is composed of a rotor blade ring and a subsequent stator blade ring, each turbine stage is composed of a stator blade ring and a subsequent rotor blade ring). During operation, the rotor blade rings rotate about the longitudinal axis 2 of the turbomachine 1. In the compressor 1a, the air taken in is compressed and then burned with added kerosene in the downstream combustion chamber 1b. The hot gas 3 flows through the hot gas channel and thereby drives the rotor blade rings which rotate about the longitudinal axis 2.

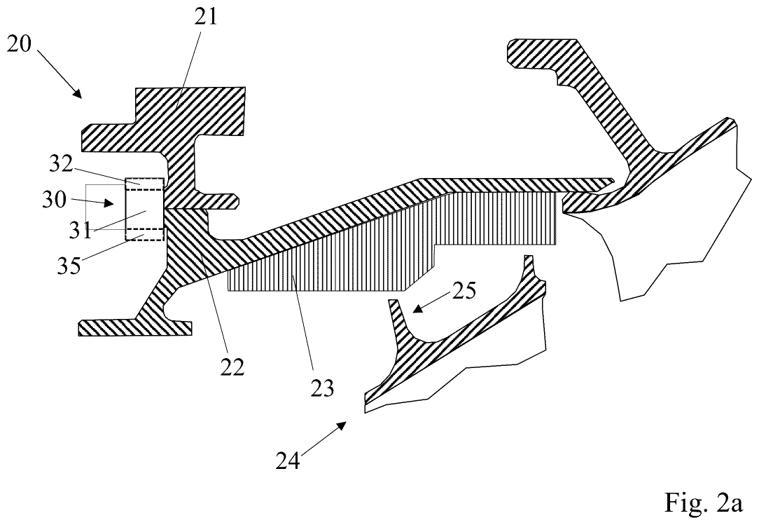

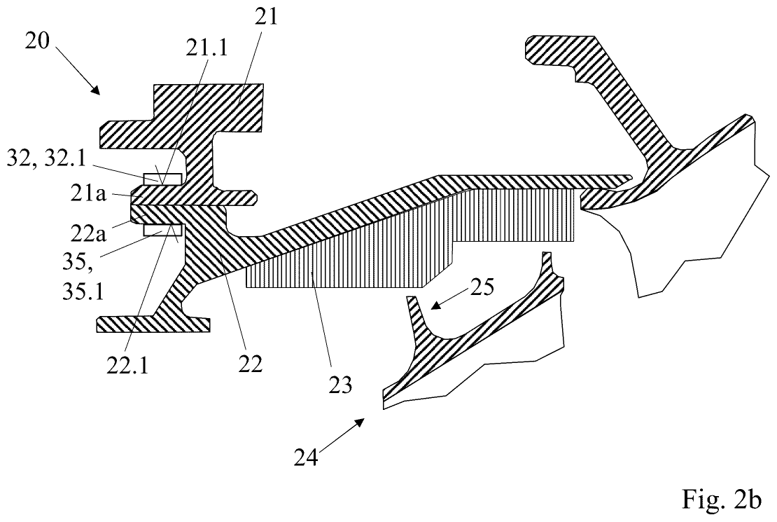

FIG. 2a shows a seal carrier segment arrangement 20 which has a housing part 21 and a seal carrier 22. A sealing structure 23, for example a honeycomb seal, is provided radially on the inside of the latter. When the rotor blade rings rotate during operation, as explained above, sealing tips 25 arranged on the rotor blades 24 can, together with the sealing structure 23, seal the annular gap radially outside the rotor blades 24.

The seal carrier 22 is mounted on the housing part 21 by means of a clamp 30, the section according to FIG. 2a running through the connecting web 31 of the clamp 30. Retaining arms 32 and a retaining element 35 lie outside the plane of the drawing according to FIG. 2a and are indicated only by dashed lines. In the further axial section according to FIG. 2b, the sectional plane is offset in the circumferential direction and extends through a first retaining arm 32.1 and a first retaining web 35.1.

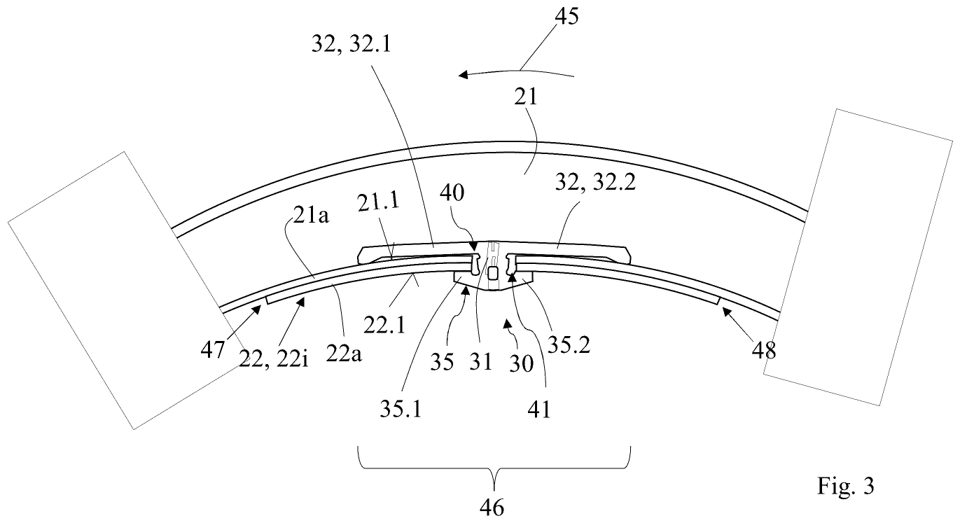

The axial view according to FIG. 3 illustrates the construction of the clamp 30 as a whole. The retaining arms 32 are provided radially on the outside of the connecting web 31 and extend in a T-shaped manner away from the connecting web 31. With the retaining arms 32, the clamp 30 rests radially inward, supported on the support surface 21.1 of the housing part 21, see also FIG. 2b in comparison.

A retaining element 35 is provided radially on the inside of the connecting web 31 and has a first and a second retaining web 35.1 and 35.2. The seal carrier 22 rests radially inward, supported on the retaining webs 35.1 and 35.2. The corresponding support surface 22.1 of the seal carrier 22 is formed on the axial projection 22a (see also FIG. 2b in comparison).

The support surface 21.1 of the housing part 21 is also formed on the axial projection 21a, the support surface 21.1 and the axial projection 21a being provided locally with an interruption 40. The connecting web 31 of the clamp 30 is arranged in the latter. The support surface 22.1 and the axial projection 22a of the seal carrier 22 are also provided with an interruption 41 which is radially aligned with the interruption 40 and is penetrated by the connecting web 31.

With respect to an extension of the seal carrier 22 or seal carrier segment 22.i in the circumferential direction 45, the clamp 30 is arranged in a middle section 46. Mechanical stress can thus be reduced at the circumferential ends 47 and 48 and thus at the joints with adjacent seal carrier segments.

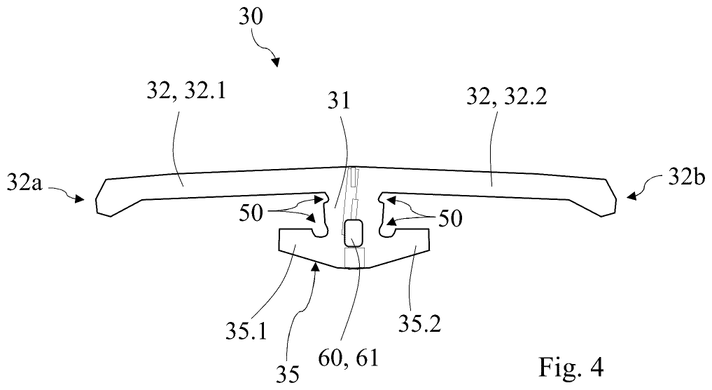

FIG. 4 shows the clamp 30 in an individual representation. The retaining arms 32 each extend farther outward than the respective retaining web 35.1 and 35.2. In detail, a first retaining arm 32.1 extends farther outward than the first retaining web 35.1 and a second retaining arm 32.2 extends farther outward than the second retaining web 35.2. The retaining arms 32 and retaining web 35.1, 35.2 each transition with a rounded edge 50 into the connecting web 31.

Furthermore, a mounting means 60 is provided on the connecting web 31, in the present case in the form of a hole 61 which passes axially through the connecting web 31 and into which a mounting tool can be placed when the clamp 30 is mounted. The free ends 32a, b of the retaining arms 32 can be deflected radially outward by means of the latter, so that they then lie radially prestressed on the support surface of the housing part.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

Turbomachine 1
Compressor 1a
Combustion chamber 1b
Turbine 1c
Longitudinal axis 2
Hot gas channel 3
Seal carrier arrangement 20
Housing part 21
Support surface 21.1.
Seal carrier 22
Seal carrier segment 22.i
Sealing structure 23
Rotor blade 24
Sealing tips 25
Clamp 30
Connecting web 31
Retaining arms 32
Retaining element 35
Retaining web 35.1, 35.2
Interruption 40
Interruption 41
Circumferential direction 45
Middle section 46
Circumferential ends 47, 48
Rounding 50
Mounting means 60
Hole 61

1. : A sealing carrier arrangement for a turbomachine, comprising:
a housing part,
a seal carrier; and
a clamp, with which the seal carrier is connected radially inward to the housing part,
wherein the clamp has a radially extending connecting web,
wherein a retaining element is provided radially on an inside of the connecting web and supports the seal carrier radially on an inside,
wherein the clamp includes retaining arms provided radially on an outside of the connecting web, and
wherein the retaining arms extend in a T-shaped manner away from the connecting web, as seen in an axial direction, and are seated on the housing part in a radially inward-supported manner.

2. The seal carrier arrangement according to claim 1, wherein a respective retaining arm of the retaining arms, with its free end, which is opposite the connecting web in a circumferential direction, is radially prestressed on a support surface of the housing part.

3. A seal carrier assembly according to claim 1, wherein a mounting element for attaching a mounting tool is provided on the connecting web.

4. A seal carrier arrangement according to claim 1, wherein the retaining element has a first and a second retaining web, which extend away from the connecting web in a circumferential direction in opposite directions to one another.

5. The seal carrier arrangement according to claim 4, wherein a respective retaining arm of the retaining arms extends farther in the circumferential direction away from the connecting web than a respective retaining web of the retaining webs.

6. The seal carrier arrangement according to claim 4, wherein the retaining arms, the connecting web and the retaining webs of the clamp lie in a common plane.

7. The seal carrier arrangement according to claim 4, wherein a rounding is provided between a respective retaining web of the retaining webs and the connecting web.

8. The seal carrier arrangement according to claim 1, wherein a rounded portion is provided between a respective retaining arm of the retaining arms and the connecting web.

9. The seal carrier arrangement according to claim 1, wherein the support surface of the housing part on which the retaining arms are seated has an interruption the connecting web of the clamp passing through the interruption.

10. The seal carrier arrangement according to claim 1, wherein the seal carrier is segmented and the clamp is provided in a middle section of a seal carrier segment in relation to an extent of the seal carrier segment taken in a circumferential direction.

11. The seal carrier arrangement according to claim 10, wherein, based on the extent of the seal carrier segment in the circumferential direction, the extent being 0% at one circumferential end and 100% at an opposite circumferential end the middle section lies between 20% and 80%.

12. The seal carrier arrangement according to claim 1, wherein the seal carrier is segmented, wherein joints between two seal carrier segments which are adjacent in the circumferential direction, are each free of the clamp.

13. The seal carrier arrangement according to claim 1, wherein the seal carrier is segmented, a respective seal carrier segment of the segmented seal carrier being mounted on the housing part with exactly one clamp in each case

14. An aircraft engine, comprising the seal carrier arrangement according to claim 1,

15. A method for producing the seal carrier arrangement according to claim 1, the method comprising placing the seal carrier on the housing part and fastening the seal carrier with the clamp.
